(19) United States
(12) Patent Application Publication
(10) Pub. No.: US 2008/0299520 A1
(43) Pub. Date: Dec. 4, 2008

(54) Foamable Dental Compositions and Methods

(76) Inventors: Mahfuza B. Ali, Mendota Heights, MN (US); Paul A. Burgio, Grant, MN (US); Sumita B. Mitra, West St. Paul, MN (US)

Correspondence Address: 3M INNOVATIVE PROPERTIES COMPANY, PO BOX 33427, ST. PAUL, MN, 55133-3427, US

(21) Appl. No.: 12/159,253

(22) PCT Filed: Dec. 22, 2006
(86) PCT No.: PCT/US2006/049248

§ 371 Date: Jun. 26, 2008

Related U.S. Application Data
(60) Provisional application No. 60/754,684, filed on Dec. 29, 2005.

(51) Int. Cl. A61C 17/00; A61Q 11/00

(52) U.S. Cl. 433/217.1; 424/49

(57) ABSTRACT

A foamable dental composition that includes a film-forming component, wherein the film-forming component forms a retentive polymeric coating on a dental surface.

### CROSS-REFERENCE TO RELATED APPLICATION

This application claims priority from U.S. Patent Application Ser. No. 60/754,684, filed Dec. 29, 2005.

### BACKGROUND

There is a consumer demand for products and methods for providing dental agents (e.g., fluoride source, whitening agent, anticaries agent, remineralizing agent) and/or retentive coatings on dental surfaces. Although many dental agents are available to both dentists and consumers, not all of the products can be conveniently administered using simple and inexpensive equipment. Furthermore, some of the products must be repeatedly applied over a sufficient period of time to effect the desired result. What is needed are new compositions and methods to provide dental agents and/or retentive coatings on dental surfaces.

### SUMMARY

The present invention provides a foamable dental composition and methods.

In one embodiment, there is provided a foamable dental composition that includes a film-forming component, wherein the film-forming component forms a retentive polymeric coating on a dental surface, wherein the retentive polymeric coating remains on the dental surface for at least 15 minutes under normal intraoral conditions. In certain embodiments, the retentive polymeric coating remains on a bovine tooth enamel surface for at least 12 hours after 2 tooth brushings according to the Colored Pigment Test Method 2 described in the Examples Section.

In one embodiment, there is provided a foamable dental composition that includes a film-forming component and a carrier, wherein the film-forming component forms a retentive polymeric coating on a dental surface, wherein the retentive polymeric coating remains on a bovine tooth enamel surface for at least 12 hours after 2 tooth brushings according to the Colored Pigment Test Method 2.

In certain embodiments, the foamable dental composition includes a carrier. In certain embodiments, the carrier includes water, alcohol (e.g., ethanol), glycerol, ethyl acetate, methyl acetate, butyl acetate, pinene, and combinations thereof.

In certain embodiments, the foamable dental composition further includes a dental agent. In certain embodiments, the dental agent is selected from the group consisting of a fluoride source, a whitening agent, an anticaries agent, a remineralizing agent, an enzyme, a breath freshener, an anesthetic, a clotting agent, an acid neutralizer, a chemotherapeutic agent, an immune response modifier, a medicament, an indicator, an antimicrobial agent, an antifungal agent, an agent for treating xerostomia, a desensitizer, and combinations thereof.

In certain embodiments, the dental agent is capable of remineralizing enamel. In certain embodiments, the dental agent is selected from the group consisting of a phosphate compound, a calcium compound, a calcium phosphate compound, hydroxyapatite, a caseinate, a filler having a surface-treatment of a phosphorus compound, a phosphorous releasing glass, a calcium releasing glass, and combinations thereof. In certain embodiments, the dental agent is a phosphate compound. In certain embodiments, the phosphate compound is selected from the group consisting of a monobasic phosphate compound, a dibasic phosphate compound, a tribasic phosphate compound, calcium glycerophosphate, and combinations thereof. In certain embodiments, the dental agent is a caseinate.

In certain embodiments, the film-forming component includes a substantive polymer. In certain embodiments, the substantive polymer is water-dispersible.

In certain embodiments, the foamable dental composition further includes a propellant. In certain embodiments, the propellant includes a gas selected from the group consisting of air, nitrogen, oxygen, carbon dioxide, helium, argon, nitrous oxide, hydrocarbons, and mixtures thereof.

In certain embodiments, the foamable dental composition further includes a foaming agent. In certain embodiments, the foaming agent is selected from the group consisting of a surfactant, surface-modified nanoparticles, a foam stabilizer, a foam-wall thickener, and combinations thereof. In certain embodiments, the foaming agent is a surfactant. In certain embodiments, the surfactant includes a polymerizable surfactant. In certain embodiments, the foaming agent includes surface-modified nanoparticles.

In certain embodiments, the foamable dental composition further includes a polymerizable component (e.g., an ethylenically unsaturated component).

In certain embodiments, the foamable dental composition further includes an additive selected from the group consisting of a buffering agent, an acidifying agent, hydrofluoric acid, an emulsifier, an emulsion oil, an emulsion stabilizer, a remineralizing promoting agent, a viscosity modifier, a thixotrope, a filler, a polyol, a flavoring agent, and combinations thereof.

In one embodiment, the present invention provides a method of forming a retentive polymeric coating on a dental surface. The method includes: providing a foamable dental composition that includes a film-forming component; foaming the composition to produce a dental foam; and applying the dental foam to a dental surface; wherein the film-forming component forms a retentive polymeric coating on the dental surface, wherein the retentive polymeric coating remains on the dental surface for at least 15 minutes under normal intraoral conditions.

In certain embodiments, applying the dental foam to a dental surface includes painting the foam, brushing the foam, syringing the foam, wiping the foam, applying the foam from a substrate, dip coating the foam, or combinations thereof. In certain embodiments, the substrate is a dental tray.

In certain embodiments, applying the dental foam to a dental surface includes dip coating the dental surface in the dental foam for less than five minutes. In certain embodiments, applying the dental foam to a dental surface includes dip coating the dental surface in the dental foam for at least one second.

In certain embodiments, the method further includes rinsing the dental surface immediately after applying the dental foam.

In certain embodiments, the dental surface includes gums or a tooth surface.

### DEFINITIONS

As used herein, the terms “normal intraoral conditions” and “normal conditions” means within the confines of a human oral cavity with mouth generally closed, normal salivating, and without any external activities involving the oral cavity, such as eating, drinking, brushing, rinsing, and the like.

As used herein, the term “dental surface” means soft or hard tissue of the oral environment including gums or a natural tooth surface (e.g., dentin or enamel) and also includes the surface of a cured dental restorative material (e.g., 3M FILTEK Supreme universal restorative) or of a ceramic tooth.

As used herein, the term “foamable dental composition” means a composition compatible with use in the oral cavity, and capable of being dispensed from a container through, for example, an aerosol or mechanical device, into a dental foam.

As used herein, the terms “dental foam,” “foam,” “foam material,” or “foam composition” are all equivalent and refer to a dental foam compatible with the oral cavity and having gas voids for a period greater than 30 seconds and no greater than 5 minutes after the dental foam has been formed from a foamable dental composition dispensed from a container. Preferably, a dental foam has gas voids for a period greater than 1 minute, more preferably about 2 minutes, and, preferably, no greater than 4 minutes after the dental foam has been formed from a foamable dental composition dispensed from a container. Preferably, a dental foam formed on a surface will not run, drip, or fall from the surface of a substrate (e.g., a dental tray) when the surface is oriented upside down. Such a characteristic is typically referred to as a “self-supporting” dental foam.

As used herein, the term “dental agent” means a component that adds value, for example in terms of an aesthetic, cosmetic, preventative, diagnostic, and/or therapeutic benefit, that results from application to a dental surface.

As used herein, the term “film-forming” means the action of a film-forming component such that, when the film-forming component (typically comprising a substantive polymer) is applied to a dental surface, a coating is formed thereon.

As used herein, the term “substantive polymer” means a polymer compatible with the oral cavity and included in a film-forming component such that, when the film-forming component is applied to a dental surface, a retentive polymeric coating is formed on and adhered to the surface for an extended period of time (at least 15 minutes) under normal conditions within the oral cavity.

As used herein, the terms “compatible with the oral cavity” and “orally compatible” refer to compositions, components, polymers, additives, and the like that are generally regarded non-irritating for use in the oral cavity.

As used herein, a “reactive” group is a group that can react under selected conditions (e.g., in the presence of free radicals or under condensation reaction conditions) with another reactive group or another component (e.g., a crosslinker or a compound with condensation reaction sites). For example, in a polymer that includes a reactive group, the reactive group can react with another reactive group and/or another component to form crosslinks through dimerization, oligomerization, and/or polymerization reactions.

As used herein, “repeating unit” or “monomeric unit” refers to a unit in a polymer that is derived from an ethylenically unsaturated monomer. For example, polypropylene includes —CH₂CH(CH₃)— monomeric units that are derived from the ethylenically unsaturated monomer propylene, CH₂═CH(CH₃).

As used herein, “hardenable” refers to a material that can be “hardened.” As used herein, “harden” is meant to encompass processes including, for example, crosslinking, dimerization, oligomerization, and/or polymerization reactions.

As used herein, “(meth)acryl” is an abbreviation intended to refer collectively to “acryl” and/or “methacryl.”

As used herein, “a,” “at least one,” and “one or more” are used interchangeably.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION OF ILLUSTRATIVE EMBODIMENTS

The present invention provides foamable dental compositions suitable for coating oral surfaces and methods. Such compositions can be used to provide retentive polymeric coatings on dental surfaces and/or to apply a dental agent to a dental surface. Preferably, the present invention provides foamable dental compositions that can be used to provide retentive polymeric coatings on dental surfaces.

Such foamable dental compositions include a film-forming component, wherein the film-forming component forms a retentive polymeric coating on a dental surface. In certain embodiments, the retentive polymeric coating remains on the dental surface for at least 15 minutes under normal intraoral conditions. Preferably the retentive polymeric coating is one that remains on the dental surface for at least 1 hour under normal intraoral conditions. In certain embodiments, the retentive polymeric coating remains on a bovine tooth enamel surface for at least 12 hours after 2 tooth brushings according to the Colored Pigment Test Method 2 described in the Examples Section.

In certain embodiments, the foamable dental composition (typically, the film-forming component thereof) includes a carrier. Examples of suitable carriers include, for example, water, alcohol (e.g., ethanol), glycerol, ethyl acetate, methyl acetate, butyl acetate, pinene, and combinations thereof.

In certain embodiments, the foamable dental composition further includes a dental agent.

In certain embodiments, the dental compositions may be hardenable (for example, polymerizable or crosslinkable). Hardenable compositions may include a reactive polymer and/or a polymerizable component different than the polymer, and an initiator system (e.g., one or more initiators). The reactive polymer and/or polymerizable component may undergo reactions with free radicals. Alternatively, the reactive polymer and/or polymerizable component may undergo condensation reactions including, for example, when in the presence of moisture. A suitable catalyst to facilitate the condensation reaction may optionally be included. Optionally, an additional compound with condensation reaction sites may also be included to act as a bridging compound between the polymers and/or polymerizable components.

In certain embodiments, the film-forming component of the foamable dental composition includes a substantive polymer. This sustantivity contributes to the retentive nature of the coating. Preferably, the substantive polymer is not significantly water soluble, although it may be water dispersible. For polymers that are not water-dispersible, carriers other than pure water are typically utilized.

In certain embodiments, the substantive polymer includes: a repeating unit that includes a polar or polarizable group; a repeating unit that includes a group selected from the group consisting of a hydrophobic hydrocarbon group, a graft polysiloxane chain, a hydrophobic fluorine-containing group, and combinations thereof; and a repeating unit that includes a modulating group. In certain embodiments of this polymer, at least one of the groups comprises a reactive group.

In certain embodiments, the film-forming component includes a substantive polymer that includes a hydrophobic segment, a hydrophilic segment, and a silicon-containing macromer segment. In certain embodiments, the substantive polymer further includes a quaternary amine segment. In certain embodiments, the substantive polymer further includes and an alkoxy silane crosslinkable segment.

In certain embodiments, the film-forming component includes a substantive polymer that includes a hydrophobic segment, a hydrophilic segment, and a quaternary amine segment. In certain embodiments the substantive polymer further includes an alkoxy silane crosslinkable segment.

In certain embodiments, the substantive polymer includes a hydrophobic segment, a hydrophilic segment, a quaternary amine segment, and an alkoxy silane crosslinkable segment. In certain embodiments, the polymer further includes a silicon-containing macromer segment.

In another embodiment, the substantive polymer includes a hydrophobic segment, a hydrophilic segment, a silicon-containing macromer segment, and an alkoxy silane crosslinkable segment.

In certain embodiments, the hydrophobic segment is selected from the group consisting of a hydrocarbon moiety including dodecyl, isobutyl, octyl, octadecyl, and combinations thereof. In certain embodiments, the hydrophobic segment is derived from a hydrophobic monomer having a weight average molecular weight of at least 100. In certain embodiments, the hydrophobic monomer has a weight average molecular weight of at most 500,000. In certain embodiments, the hydrophobic segment is a fluorine-containing segment.

In certain embodiments, the hydrophilic segment is selected from the group consisting of carboxylic acids, lower alkyl (e.g., methyl, ethyl, and propyl) esters, hydroxyalkyl esters, alkoxyalkyl esters aminoalkyl esters, alkylaminoalkyl esters, dialkylaminoalkyl esters, polyethylene glycol esters, polypropylene glycol esters, trialkylammoniumalkyl esters wherein the counterion can be halide, acetate, propionate, laurate, palmitate, stearate, or combinations thereof; and combinations thereof.

In certain embodiments, the quaternary amine segment is selected from the group consisting of trialkylammoniumalkyl ester tetrafluoroborates, trialkylammoniumalkyl ester fluorophosphates, trialkylammoniumalkyl ester halides, and combinations thereof.

In certain embodiments, the alkoxy silane crosslinkable segment is a (trialkoxysilyl)alkyl.

In certain embodiments, the silicon-containing macromer segment includes a polysiloxane chain having a molecular weight of at least 500.

Dental compositions of the present invention may be prepared as a single-part liquid, foam, paste, or gel by combining the appropriate components. For example, the polymer (typically a substantive polymer) and the dental agent may be mixed at the desired temperature (e.g., room temperature). Alternatively, compositions of the present invention may be prepared as multiple-part systems comprising liquids, foams, pastes, gels, or combinations thereof, that are mixed prior to delivery to the dental surface. Such multiple-part systems may provide shelf stability that may not exist in single-part compositions including, for example, compositions including an initiator system based on two-component redox chemistry, and compositions including an additive (e.g., an initiator or catalyst) that is incompatible with other materials in the composition.

If the composition includes a polymer with a crosslinkable segment, typically, the composition is provided to the user with a catalyst (e.g., stannous octoate). After application of the dental composition to the dental surface, the catalyst is applied to crosslink the polymer on the dental surface.

### Dental Agents

In some embodiments, compositions of the present invention include, or may optionally include, dental agents (e.g., dental additives for dental compositions that are suitable for use in the oral environment). Exemplary dental agents include, for example, fluoride sources, whitening agents, anticaries agents (e.g., xylitol), remineralizing agents, enzymes, breath fresheners, anesthetics, clotting agents, acid neutralizers, chemotherapeutic agents, immune response modifiers, medicaments, indicators (e.g., dyes, pigments), wetting agents, antimicrobial agents, antifungal agents, stabilizers, agents for treating xerostomia, desensitizers, and combinations thereof. Preferably the dental agents are suitable for use in the oral environment.

In some embodiments, the substantive polymer can act as a dental agent. For example, when the polymer includes an antimicrobial quaternary amine segment, a remineralizing phosphorous containing segment, a remineralizing calcium containing segment, a fluoride releasing segment, or combinations thereof, the polymer itself provides a dental agent.

Useful fluoride sources used in the present invention may be any material that has the effect of releasing fluoride ion into the oral cavity or onto a dental surface. Typically, useful fluoride sources have the effect of desensitizing teeth by occluding dentinal tubules and remineralizing enamel. Useful fluoride sources include, for example, sodium fluoride, sodium monofluorophosphate, stannous fluoride, fluoroalkyl phosphate salts such as monammonium 1,1,7-trihydroperfluoroheptyl phosphate, quaternary ammonium fluorides such as doceyltrimethyl-ammonium fluoride, and combinations thereof. Other fluoride sources are disclosed in U.S. Pat. No. 5,071,637 (Pellicano), for example.

In certain embodiments, the substantive polymers disclosed herein also include a repeating unit that includes a fluoride releasing group. A preferred fluoride releasing group includes tetrafluoroborate anions as disclosed, for example, in U.S. Pat. No. 4,871,786 (Aasen et al.). A preferred repeating unit of a fluoride releasing group includes trimethylammoniumethyl methacrylate.

Further, suitable precursors for fluoride ion include, for example, ammonium fluoride, sodium fluoride, stannous fluoride, tetrabutyl ammonium fluoride, tetrabutyl ammonium hexafluorophosphate, sodium fluorophosphates, ammonium hydrogen difluoride, hexafluorosilicic acid and salts thereof, monofluorophosphoric acid and salts thereof, hexafluorophosphoric acid and salts thereof, and combinations thereof.

Useful remineralizing agents used in the present invention may be any material that is capable of remineralizing enamel. Useful remineralizing agents include, for example, phosphate compounds, calcium compounds, calcium phosphate compounds, hydroxyapatite, caseinates, fillers having a surface-treatment of a phosphorus compound, phosphorous releasing glasses, calcium releasing glasses, and combinations thereof. In certain embodiments, the dental agent is a phosphate compound. In certain embodiments, the phosphate compound is a monobasic phosphate compound, a dibasic phosphate compound, a tribasic phosphate compound, calcium glycerophosphate, or combinations thereof. In certain embodiments, the dental agent is a caseinate. In certain embodiments, the caseinate is a salt of calcium, phosphate, fluoride, or combinations thereof. Various remineralizing agents are described in U.S. Pat. No. 6,497,858 (Takatsuka et al.) and in U.S. patent application Ser. Nos. 10/989,779; 10/989,779; 10/989,780; and 60/628,336; each of which was filed on Nov. 16, 2004.

Useful whitening agents used in the present invention may be any material that has the effect of whitening teeth. Useful whitening agents include, for example, hypochlorites (e.g., sodium hypochlorite), peroxides, hydroperoxides, hydrogen peroxide, peracids (also known as peroxyacids), carbamide peroxide (i.e., the urea complex of hydrogen peroxide, CO(NH₂)₂H₂O₂, also known as urea hydrogen peroxide, hydrogen peroxide carbamide, or perhydrol-urea), and combinations thereof.

Useful breath fresheners include zinc chloride.

Useful antimicrobial agents include agents for controlling bacteria growth associated with caries, periodontitis and halitosis. Such agents include, for example, chlorohexidine, glycerol esters of fatty acids optionally in combination with acidic components, propylene glycol esters of fatty acids optionally in combination with acidic components, and quaternary ammonium compounds.

The concentration of a dental agent in the composition can vary depending upon its activity. Compositions of the present invention may be adjusted as desired to include the amount of dental agent as desired for the specific application. Preferably, the dental composition includes at least 0.05% by weight, more preferably at least 0.1% by weight, and most preferably at least 0.5% by weight of the dental agent, based on the total weight of the composition. Preferably, the dental composition includes at most 50% by weight, more preferably at most 45% by weight, and most preferably at most 40% by weight of the dental agent, based on the total weight of the composition.

### Substantive Polymers

Polymers (e.g., substantive polymers) used in the compositions (e.g., foamable dental compositions and other compositions for applying a retentive polymeric coating to a dental surface) of the present application include a repeating unit that includes a polar or polarizable group as described herein below. In certain embodiments, the polymers also include a repeating unit that includes a fluoride releasing group, a repeating unit that includes a hydrophobic hydrocarbon group, a repeating unit that includes a graft polysiloxane chain, a repeating unit that includes a hydrophobic fluorine-containing group, a repeating unit that includes a modulating group, or combinations thereof, as described herein below. In some embodiments, the polymer optionally includes a reactive group. Suitable reactive groups (e.g., ethylenically unsaturated groups, epoxy groups, or silane moieties capable of undergoing a condensation reaction) are disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

In one embodiment, a dental composition includes a polymer including: a repeating unit including a polar or polarizable group; and a repeating unit including a fluoride releasing group (e.g., tetrafluoroborate anions). Preferably, the repeating unit including the polar or polarizable group is different than the repeating unit including the fluoride releasing group.

In another embodiment, the composition includes a polymer including: a repeating unit including a polar or polarizable group; and a repeating unit including a group selected from the group consisting of a hydrophobic hydrocarbon group, a graft polysiloxane chain, a hydrophobic fluorine-containing group, and combinations thereof. Preferably the hydrophobic hydrocarbon segment is derived from a hydrophobic monomer having a weight average molecular weight of at least 100. Preferably the graft polysiloxane chain has a molecular weight of at least 500. Preferably, the repeating unit including the polar or polarizable group is different than the repeating unit including the group selected from the group consisting of a hydrophobic hydrocarbon group, a graft polysiloxane chain, a hydrophobic fluorine-containing group, and combinations thereof.

Optionally the polymer includes reactive groups.

Exemplary methods of preparing the recited polymers are well known in the art and include, for example, free radical polymerization conditions as disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

Dental compositions of the present invention preferably include at least 5% by weight polymer, more preferably at least 15% by weight polymer, and most preferably at least 37% by weight polymer, based on the total weight of the composition. Dental compositions of the present invention preferably include at most 99.95% by weight polymer, more preferably at most 99.9% by weight polymer, and most preferably at most 99.5% by weight polymer, based on the total weight of the composition.

### Polar or Polarizable Groups

Repeating units including a polar or polarizable group are typically hydrophilic groups and are derived from vinylic monomers such as acrylates, methacrylates, crotonates, itaconates, and the like. The polar groups can be acidic, basic or salt. These groups can also be ionic or neutral.

Examples of polar or polarizable (e.g., hydrophilic) groups include neutral groups such as hydroxy, thio, substituted and unsubstituted amido, cyclic ethers (such as oxanes, oxetanes, furans and pyrans), basic groups (such as phosphines and amines, including primary, secondary, tertiary amines), acidic groups (such as oxy acids, and thiooxyacids of C, S, P, B), ionic groups (such as quarternary ammonium, carboxylate salt, sulfonic acid salt and the like), and the precursors and protected forms of these groups. Additionally, a polar or polarizable group could be a macromonomer. More specific examples of such groups follow.

Polar or polarizable groups may be derived from mono- or multifunctional carboxyl group containing molecules represented by the general formula:

CH₂═CR²G-(COOH)_{d}

where R²=H, methyl, ethyl, cyano, carboxy or carboxymethyl, d=1-5 and G is a bond or a hydrocarbyl radical linking group containing from 1-12 carbon atoms of valence d+1 and optionally substituted with and/or interrupted with a substituted or unsubstituted heteroatom (such as O, S, N and P). Optionally, this unit may be provided in its salt form. The preferred monomers in this class are acrylic acid, methacrylic acid, itaconic acid, and N-acryloyl glycine.

Polar or polarizable groups may, for example, be derived from mono- or multifunctional hydroxy group containing molecules represented by the general formula:

CH₂═CR²—CO-L-R³—(OH)_{d}

where R²=H, methyl, ethyl, cyano, carboxy or carboxyalkyl, L=O, NH, d=1-5 and R³ is a hydrocarbyl radical of valence d+1 containing from 1-12 carbon atoms. Suitable monomers in this class are hydroxyethyl (meth)acrylate, hydroxypropyl (meth)acrylate, hydroxybutyl (meth)acrylate, glycerol mono(meth)acrylate, tris(hydroxymethyl)ethane monoacrylate, pentaerythritol mono(meth)acrylate, N-hydroxymethyl (meth)acrylamide, hydroxyethyl (meth)acrylamide, and hydroxypropyl (meth)acrylamide.

Polar or polarizable groups may alternatively be derived from mono- or multifunctional amino group containing molecules of the general formula:

CH₂═CR²—CO-L-R³—(NR⁴R⁵)_{d}

where R², L, R³, and d are as defined above and R⁴ and R⁵ are H or alkyl groups of 1-12 carbon atoms or together they constitute a carbocyclic or heterocyclic group. Suitable monomers of this class are aminoethyl (meth)acrylate, aminopropyl (meth)acrylate, N,N-dimethylaminoethyl (meth)acrylate, N,N-diethylaminoethyl (meth)acrylate, N,N-dimethylaminopropyl (meth)acrylamide, N-isopropylaminopropyl (meth)acrylamide, and 4-methyl-1-acryloyl-piperazine.

Polar or polarizable groups may also be derived from alkoxy substituted (meth)acrylates or (meth)acrylamides such as methoxyethyl (meth)acrylate, 2-(2-ethoxyethoxy)ethyl (meth)acrylate, polyethylene glycol mono(meth)acrylate or polypropylene glycol mono(meth)acrylate.

Polar or polarizable groups units may be derived from substituted or unsubstituted ammonium monomers of the general formula:

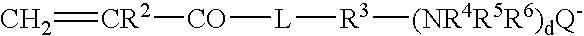

where R², R³, R⁴, R⁵, L and d are as defined above, and where R⁶ is H or alkyl of 1-12 carbon atoms and Q⁻ is an organic or inorganic anion. Suitable examples of such monomers include 2-N,N,N-trimethylammonium ethyl (meth)acrylate, 2-N,N,N-triethylammonium ethyl (meth)acrylate, 3-N,N,N-trimethylammonium propyl (meth)acrylate, N(2-N′,N′,N′-trimethylammonium) ethyl (meth)acrylamide, N-(dimethyl hydroxyethyl ammonium) propyl (meth)acrylamide, or combinations thereof, where the counterion may include fluoride, chloride, bromide, acetate, propionate, laurate, palmitate, stearate, or combinations thereof. The monomer can also be N,N-dimethyl diallyl ammonium salt of an organic or inorganic counterion.

Ammonium group containing polymers can also be prepared by using as the polar or polarizable group any of the amino group containing monomer described above, and acidifying the resultant polymers with organic or inorganic acid to a pH where the pendant amino groups are substantially protonated. Totally substituted ammonium group containing polymers may be prepared by alkylating the above described amino polymers with alkylating groups, the method being commonly known in the art as the Menschutkin reaction.

Polar or polarizable groups can also be derived from sulfonic acid group containing monomers, such as vinyl sulfonic acid, styrene sulfonic acid, 2-acrylamido-2-methyl propane sulfonic acid, allyloxybenzene sulfonic acid, and the like. Alternatively, polar or polarizable groups may be derived from phosphorous acid or boron acid group-containing monomers. These monomers may be used in the protonated acid form as monomers and the corresponding polymers obtained may be neutralized with an organic or inorganic base to give the salt form of the polymers.

Exemplary polar or polarizable groups are disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

Preferred repeating units of a polar or polarizable group include acrylic acid, itaconic acid, N-isopropylacrylamide, or combinations thereof.

### Fluoride Releasing Groups

Suitable fluoride releasing groups include fluoride salts as disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.). A preferred fluoride releasing group includes tetrafluoroborate anions as disclosed, for example, in U.S. Pat. No. 4,871,786 (Aasen et al.). A preferred repeating unit of a fluoride releasing group includes trimethylammoniumethyl methacrylate.

### Hydrophobic Hydrocarbon Groups

An exemplary hydrophobic hydrocarbon group is derived from an ethylenically unsaturated preformed hydrocarbon moiety (i.e., a hydrophobic monomer) having a weight average molecular weight greater than 100. Preferably the hydrocarbon moiety has a molecular weight of at least 160. Preferably the hydrocarbon moiety has a molecular weight of at most 500,000, more preferably at most 100,000, and even more preferably at most 50,000. The hydrocarbon moiety may be aromatic or non-aromatic in nature, and optionally may contain partially or fully saturated rings. Preferred hydrophobic hydrocarbon moieties are dodecyl, isobutyl, octyl and octadecyl acrylates and methacrylates. Other preferred hydrophobic hydrocarbon moieties include macromonomers of the desired molecular weights prepared from polymerizable hydrocarbons, such as ethylene, styrene, alpha-methyl styrene, vinyltoluene, and methyl methacrylate.

Exemplary hydrophobic hydrocarbon groups are disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

### Hydrophobic Fluorine-Containing Groups

Exemplary repeating units of hydrophobic fluorine-containing groups include acrylic or methacrylic acid esters of 1,1-dihydroperfluoroalkanols and homologs: CF₃(CF₂)ₓCH₂ OH and CF₃(CF₂)ₓ(CH₂)_{y}OH, where x is zero to 20 and y is at least 1 up to 10; ω-hydrofluoroalkanols (HCF₂(CF₂)ₓ(CH₂)_{y}OH), where x is 0 to 20 and y is at least 1 up to 10; fluoroalkylsulfonamido alcohols; cyclic fluoroalkyl alcohols; and CF₃(CF₂CF₂O)_{q}(CF₂O)ₓ(CH₂)_{y}OH, where q is 2 to 20 and greater than x, x is 0 to 20, and y is at least 1 up to 10.

Preferred repeating units of a hydrophobic fluorine-containing group include 2-(methyl(nonafluorobutyl)sulfonyl)amino)ethyl acrylate, 2-(methyl(nonafluorobutyl)sulfonyl)amino)ethyl methacrylate, or combinations thereof.

Exemplary hydrophobic fluorine containing groups are disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

### Graft Polysiloxane Chains

The graft polysiloxane chain is derived from an ethylenically unsaturated preformed organosiloxane chain. The molecular weight of this unit is generally at least 500. Preferred repeating units of a graft polysiloxane chain include a silicone macromer.

Monomers used to provide the graft polysiloxane chain of this invention are terminally functional polymers having a single functional group (vinyl, ethylenically unsaturated, acryloyl, or methacryloyl group) and are sometimes termed macromonomers or “macromers.” Such monomers are known and may be prepared by methods as disclosed, for example, in U.S. Pat. No. 3,786,116 (Milkovich et al.) and U.S. Pat. No. 3,842,059 (Milkovich et al.). The preparation of polydimethylsiloxane macromonomer and subsequent copolymerization with vinyl monomer have been described in several papers by Y. Yamashita et al., [Polymer J. 14, 913 (1982); ACS Polymer Preprints 25 (1), 245 (1984); Makromol. Chem. 185, 9 (1984)].

Exemplary polysiloxane chains are disclosed, for example, in U.S. Pat. No. 5,468,477 (Kumar et al.), U.S. Pat. No. 5,607,663 (Rozzi et al.), U.S. Pat. No. 5,662,887 (Rozzi et al.), U.S. Pat. No. 5,725,882 (Kumar et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

### Modulating Groups

Exemplary modulating groups are derived from acrylate or methacrylate or other vinyl polymerizable starting monomers and optionally contain functionalities that modulate properties such as glass transition temperature, solubility in the carrier medium, hydrophilic-hydrophobic balance and the like.

Examples of modulating groups include the lower to intermediate methacrylic acid esters of 1-12 carbon straight, branched or cyclic alcohols. Other examples of modulating groups include styrene, vinyl esters, vinyl chloride, vinylidene chloride, acryloyl monomers and the like.

Additional exemplary modulating groups are disclosed, for example, in U.S. Pat. No. 5,607,663 (Rozzi et al.), U.S. Pat. No. 5,662,887 (Rozzi et al.), U.S. Pat. No. 5,866,630 (Mitra et al.), U.S. Pat. No. 5,876,208 (Mitra et al.), U.S. Pat. No. 5,888,491 (Mitra et al.), and U.S. Pat. No. 6,312,668 (Mitra et al.).

### Initiator System

Dental compositions of the present invention optionally include an initiator system or catalyst that enables the composition to be hardened (e.g., polymerized or crosslinked). For example, visible and/or near-infrared photoinitiator systems may be used to initiate photopolymerization in compositions including free-radically polymerizable components. For example, a monomer can be combined with a three component or ternary photoinitiator system including a sensitizer, an electron donor, and an iodonium salt as disclosed, for example, in U.S. Pat. No. 5,545,676 (Palazzotto et al.). Alternatively, the composition may include a binary initiator system including a sensitizer (e.g., camphorquinone) and an electron donor (e.g., a secondary or a tertiary alkyl amine compound as disclosed, for example, in U.S. Pat. No. 4,071,424 (Dart et al.)).

Another class of useful photoinitiators includes acylphosphine oxides, as disclosed in European Pat. Publ. No. 173,567 (Ying). Such acylphosphine oxides are of the general formula (R)₂ P(═O)C(═O)—R¹, wherein each R individually can be a hydrocarbyl group (e.g., alkyl, cycloalkyl, aryl, and aralkyl), which may be substituted with a halo-, alkyl- or alkoxy-group, or the two R groups may be joined to form a ring along with the phosphorous atom, and wherein R¹ is a hydrocarbyl group, an S-, O-, or N-containing five- or six-membered heterocyclic group, or a -Z-C(═O)—P(═O)— (R)₂ group, wherein Z represents a divalent hydrocarbyl group (e.g., alkylene or phenylene) having from 2 to 6 carbon atoms.

Preferred acylphosphine oxides useful in the invention are those in which the R and R¹ groups are phenyl or lower alkyl- or lower alkoxy-substituted phenyl. By “lower alkyl” and “lower alkoxy” is meant such groups having from 1 to 4 carbon atoms. Most preferably, the acylphosphine oxide is bis(2,4,6-trimethylbenzoyl)phenyl phosphine oxide available under the trade designation IRGACURE 819 from Ciba Specialty Chemicals (Tarrytown, N.Y.).

The use of redox catalysts including oxidants and reductants for inducing free radical polymerization in multi-component systems is also useful for generating hardened gels. A preferred mode of initiating the polymerization reaction uses oxidizing and reducing agents as a redox catalyst system. Various redox systems optionally including microencapsulated reducing and/or oxidizing agents are disclosed in U.S. Pat. No. 5,154,762 (Mitra et al.).

Preferably, the oxidizing agent reacts with or otherwise cooperates with the reducing agent to produce free radicals. The free radicals are capable of initiating polymerization of the ethylenically unsaturated moiety. The oxidizing and reducing agents preferably are sufficiently soluble and are present in an amount sufficient to permit an adequate free radical reaction rate as disclosed in U.S. Pat. No. 6,136,885 (Rusin et al.).

A preferred class of oxidizing agents includes persulfates (e.g., sodium, potassium, ammonium, and alkyl ammonium persulfates). Another preferred class of oxidizing agents includes peroxides or peroxide salts (e.g., hydrogen peroxide, benzoyl peroxide, and hydroperoxides including, for example cumene hydroperoxide, tert-butyl hydroperoxide, tert-amyl hydroperoxide, and 2,5-dihydroperoxy-2,5-dimethylhexane). Other preferred oxidizing agents include salts of cobalt (III) and iron (III), perboric acid and its salts, and salts of a permanganate anion. Combinations of any of the above mentioned oxidizing agents can also be used.

Preferred reducing agents include, for example, amines (e.g., aromatic amines), ascorbic acid, metal complexed ascorbic acid, cobalt (II) chloride, ferrous chloride, ferrous sulfate, hydrazine, hydroxylamine, oxalic acid, thiourea, and salts of dithionite, thiosulfate, benzene sulfinate, or sulfite anions.

If initiators are included in compositions of the present invention, the compositions preferably include at least 0.01% by weight of the initiator and more preferably at least 0.1% by weight of the initiator, based on the total weight of the composition. If initiators are included in compositions of the present invention, the compositions preferably include at most 10% by weight of the initiator and more preferably at most 5% by weight of the initiator, based on the total weight of the composition.

### Foamable Dental Compositions and Foams

The foamable dental compositions of the present invention can include, for example, one or more foaming agents and/or one or more propellants.

Suitable propellants include, for example, a gas. Suitable gases include, for example, air, nitrogen, oxygen, carbon dioxide, helium, argon, nitrous oxide, hydrocarbons (e.g., propane, n-butane, isobutene, blended propane and butane), and mixtures thereof.

The amount of propellant in a foamable dental composition of the present invention is preferably at least 5 wt-%, more preferably at least 7 wt-%, and most preferably at least 10 wt-%, based on the total weight of the composition. The amount of foaming agent in a composition of the present invention is preferably no greater than 20 wt-%, more preferably no greater than 15 wt-%, and most preferably no greater than 10 wt-%, based on the total weight of the composition.

Suitable foaming agents include, for example, surfactants, surface-modified nanoparticles, foam stabilizers, foam-wall thickeners, and combinations thereof.

Suitable surfactants include, for example, ionic, nonionic, cationic, amphoteric, or combinations thereof. Suitable surfactants may also be polymerizable surfactants. Examples of suitable surfactants are disclosed, for example, in U.S. Pat. No. 6,361,761 (Joziak et al.), U.S. Pat. No. 5,071,637 (Pellicano), and U.S. Pat. No. 5,824,289 (Stoltz). Suitable surfactants include TOMADOL 45-13 available from Tomah Reserve Inc. (Reserve, La.), and UNITHOX 720 available from Baker Petrolite Corp., Tulsa, Okla.

In some embodiments, the substantive polymer can act as the surfactant, for example, when the polymer includes amphoteric segments, such as a quaternary amine segment, or includes the combination of hydrophobic and hydrophilic segments.

The amount of surfactant in a foamable composition of the present invention is preferably at least 0.5 wt-%, more preferably at least 2 wt-%, and even more preferably at least 3 wt-%, based on the total weight of the composition. The amount of surfactant in a foamable composition of the present invention is preferably no greater than 60 wt-%, more preferably no greater than 50 wt-%, and even more preferably no greater than 20 wt-%, based on the total weight of the composition.

Suitable surface-modified nanoparticles have an average particle diameter of less than 100 nanometers. Examples of such surface-modified nanoparticles are disclosed, for example, in U.S. Pat. No. 6,586,483 (Kolb).

Suitable foam stabilizers include, for example, cetyl alcohol, sodium monostearate, cocoamide diethanolamine, lauramide diethanolamine, propylene glycol 14-butyl ether, or mixtures thereof. The amount of foam stabilizer in a foamable composition of the present invention is preferably at least 0.5 wt-%, more preferably at least 2 wt-%, and even more preferably at least 3 wt-%, based on the total weight of the composition. The amount of foam stabilizer in a foamable composition of the present invention is preferably no greater than 60 wt-%, more preferably no greater than 50 wt-%, and even more preferably no greater than 20 wt-%, based on the total weight of the composition.

In some embodiments, the substantive polymer can act as the foam stabilizer, for example when the polymer includes an acidic and/or basic segment that aids in adjusting the pH of the foamable dental composition to an optimum level.

Suitable foam-wall thickeners include, for example, glycerol, sorbitol, hydrogenated starch hydrolysate, 2-octadecanol, or mixtures thereof. Commercially available foam-wall thickeners are available under the trade names HYSTAR TPF (Lonza, Inc., Fair Lawn, N.J.), TOMADOL 45-13 (Tomah Reserve Inc.), and UNITHOX 720 (Baker Petrolite Corp.). The amount of foam wall thickener in a foamable composition of the present invention is preferably at least 0.5 wt-%, more preferably at least 2 wt-%, and even more preferably at least 3 wt-%, based on the total weight of the composition. The amount of foam wall thickener in a foamable composition of the present invention is preferably no greater than 60 wt-%, more preferably no greater than 50 wt-%, and even more preferably no greater than 20 wt-%, based on the total weight of the composition.

Various other components of foamable compositions and methods of making foamable compositions and foams, including further information about propellants, foaming agents, aerosol and non-aerosol containers, nozzles, etc., are described, for example, in U.S. Pat. No. 6,142,338 (Pellicano), U.S. Pat. No. 5,071,637 (Pellicano), and U.S. Pat. No. 5,824,289 (Stoltz).

### Other Optional Additives

Compositions of the present invention can also include additives (other than the additives described above for preparing foamable compositions). Such additives include, for example, buffering agents, acidifying agents, hydrofluoric acid, emulsifiers, emulsion oils, emulsion stabilizers, remineralizing promoting agents, viscosity modifiers, thixotropes, fillers, polyols, flavoring agents (e.g., sweetening agents), and combinations thereof.

The selection and amount of such additives for desired effects is well-known to one of skill in the art.

### Methods

Methods of the present invention provide for the treatment of dental surfaces that include soft and hard tissues, including human and animal tissues. Hard tissues include, for example, bone, teeth, and the component parts of teeth (e.g., enamel, dentin, and cementum). Soft tissues include, for example, mucosa (e.g., tongue, gingiva, and throat). In some embodiments, dental surfaces include a hardened restorative surface in the oral cavity.

Dental compositions of the present invention may be delivered to the desired site by any method as desired. For example, the composition may be delivered directly onto a dental surface from a container or dispenser. Suitable containers or dispensers include, for example, bottles, vials, syringes, and tubes. The ability to deliver the composition as a bulk liquid from a needle tip or as a fine mist from an aerosol provides versatility in application. Alternatively, the composition can be delivered by using a brush, sponge, applicator, or swab to paint or coat the composition onto the tissue. For some applications it may be desirable to apply the composition to larger areas. For those particular applications, the compositions may be delivered via spray or aerosol dispensers or by simply rinsing the entire tissue area (e.g., the oral cavity) with the composition.

Alternatively, the composition can be applied to a substrate, and the substrate having the composition thereon (or therein as in the case of a dental tray) can be applied to the desired surface. Suitable substrates include, for example, polymeric films, paper, and woven and non-woven sheets. A preferred substrate is a tray type dispenser, for example, a dental tray. Methods of using dental trays are known and described, for example, in U.S. Pat. No. 6,361,761 (Joziak et al.), U.S. Pat. No. 5,071,637 (Pellicano), and U.S. Pat. No. 5,824,289 (Stoltz). The composition can also be applied to a brush, spatula, medical/dental instrument, or an applicator prior to application to the desired surface.

In certain preferred embodiments, the compositions of the present invention are applied to a dental surface by methods including, for example, painting, brushing, syringing, wiping, applying the dental composition from a substrate (e.g., a dental tray), dip coating, or combinations thereof.

When the dental compositions of the present invention include two or more parts, the two or more parts are preferably mixed just prior to or during the application process. Suitable mixing devices include, for example, static mixing devices.

The composition is preferably allowed to stand on the surface of the dental surface long enough to provide the desired effect. The standing time will vary depending on the particular composition employed, the type of dental surface, the intended use, and the time available for carrying out the procedure. For many applications, the composition may be allowed to remain on the dental surface for an extended period of time.

In certain embodiments, preferred methods include dip coating the dental surface in the dental foam for less than five minutes, more preferably for less than one minute, and even more preferably for less than 15 seconds. Other preferred methods include dip coating the dental surface in the dental foam for at least one second, and more preferably for at least 5 seconds. Other preferred methods include rinsing the dental surface immediately after applying the foamable dental composition.

If the composition includes a polymer with a crosslinkable segment, typically, the composition is provided to the user with a catalyst (e.g., stannous octoate). There are at least two possible ways to apply a two part system to the teeth via a foam. One method involves using a foam dispenser that allows part A to be mixed with part B as the components are is extruded from the nozzle. In a second method, after application of the dental composition to the dental surface, the catalyst is applied to crosslink the polymer on the dental surface

Typically, in certain embodiments, the polymer is “nonpolymerizable” and is hardened and adhered to the tooth simply by coating, dipping, etc. Although for some embodiments of the present invention, dental compositions may be hardened (e.g., polymerized or crosslinked), for example, by inducing a reactive polymer to react. If the dental composition includes an optional polymerizable component different than the reactive polymer, hardening of the composition may also include polymerization of the polymerizable component. For example, when the reactive polymer or the polymerizable component includes an ethylenically unsaturated group, polymerization may be induced by the application of actinic radiation. Preferably the composition is irradiated with radiation having a wavelength of 400 to 1200 nanometers, and more preferably with visible radiation. Visible light sources include, for example, the sun, lasers, metal vapor (e.g., sodium and mercury) lamps, incandescent lamps, halogen lamps, mercury arc lamps, fluorescent room light, flashlights, light emitting diodes, tungsten halogen lamps, and xenon flash lamps.

Alternatively, for embodiments of the present invention in which the reactive polymer or the polymerizable component includes an ethylenically unsaturated group, the composition may include two or more parts, with one part including an oxidizing agent, and another part including a reducing agent.

Objects and advantages of this invention are further illustrated by the following examples, but the particular materials and amounts thereof recited in these examples, as well as other conditions and details, should not be construed to unduly limit this invention. Unless otherwise indicated, all parts and percentages are on a weight basis, all water is deionized water, and all molecular weights are weight average molecular weight.

### EXAMPLES

### Test Methods

### Colored Pigment Test Method 1

To a series of test samples (some of which contained a substantive polymer) was added 0.014% by weight of a red pigment (D&C Red 30 Talc Lake Sensient code: K7094, Sensient Technologies, St. Louis, Mo.). The resulting dye-containing samples were then evaluated for retention on teeth by using the following procedure.

Extracted bovine teeth were removed from their storage container filled with water, and briefly patted with a paper towel. A different test sample was then individually brushed on each tooth and after 1 minute, the coated teeth were immersed in a water bath that was maintained at 37° C. and continuously agitated. The teeth were visually monitored at specific time intervals for specific changes in the intensity and continuity of the red color on the tooth. The period of time that the red-colored polymer coating remained on a tooth was reported as the “Retention Time.” At the conclusion of the test period, the coated teeth were removed from the water bath and probed gently to gauge the integrity of the tooth coatings.

### Colored Pigment Test Method 2

Red pigment was added to test samples (some of which contained substantive polymers) and the resulting dye-containing test samples applied to bovine teeth as described for the Colored Pigment Test Method 1. However, in this Test Method the teeth were removed from the 37° C. water bath and, after about 16 minutes, brushed using a specially designed Toothbrush Abrasion Machine (MDRCBB University of Minnesota Dental School, Minneapolis, Minn.). The machine applied a specific force of about 200 g to the toothbrush that glided over the surface of a coated bovine tooth for 26 cycles. One cycle is equivalent to machine brushing with one back-and-forth motion for about one second and allowing about 1 second between brushings. It is estimated that 26 cycles took about 1 minute and correlate to approximately one day (about 12 hours) of typical teeth brushing (morning and evening brushings) by an individual person. During brushing, the tooth and brush were surrounded by a slurry of 50% by weight CREST toothpaste in water.

Following the 26 cycles (=“1 Equivalent Test Day” or “1 Test Day”), the tooth was visually observed by two observers and each observer estimated the amount of colored coating remaining on the tooth surface as a percentage of the entire surface. The estimates were reported as an average percent of coating remaining on the tooth. This process was then continued for multiple “Test Days” depending on the study.

### Colored Pigment Test Method 3

Colored Pigment Test Method 3 was conducted basically the same was as Colored Pigment Test Method 2, except that hand tooth brushing was used in place of the Toothbrush Abrasion Machine and attempted to simulate the 26 cycles of the Machine to again represent one typical day of tooth brushing. The testing results were obtained and reported in the same manner as Colored Pigment Test Method 2.

### Fluoride Release Test Method

The rate of release of fluoride ions from test samples was measured by the following procedure. A dental substrate surface was prepared by coating FILTEK Z250 Universal restorative (3M Company, St. Paul, Minn.) on a glass microscope slide about 1 cm from the edge of the slide and then light curing the restorative coating according to manufacturer's directions. A test sample was then brushed onto the cured restorative surface. The slide was weighed before and after coating the test samples in order to determine the total weight of the test sample on the slide. One minute after applying the test sample to the restorative surface, the treated slide was placed into a container filled with 25 ml of distilled water and the resulting assembly placed in a 37° C. oven for the duration of the study. The water was replenished at specified time intervals and the fluoride ion activity in the distilled water was measured with a Cole Parmer fluoride ion specific electrode (Cole-Parmer Instrument Company, Vernon Hills, Ill.) according to manufacturer's directions and standard methodology. Final results were reported as microgram or milligram (mg) of fluoride per gram of test sample.

Abbreviations/Definitions

| | |
|---|---|
| NIPAAM | N-Isopropyl acrylamide (Sigma-Aldrich, |
| | St. Louis, MO) |
| IOA | Isooctyl acrylate (Sigma-Aldrich) |
| IBoA | Isobornyl acrylate (Sigma-Aldrich) |
| IBMA | Isobutyl methacrylate (Sigma-Aldrich) |
| AA | Acrylic acid (Sigma-Aldrich) |
| MEA | Methoxyethyl acrylate (San Ester Corp., |
| | New York, NY) |
| ITA | Itaconic acid (Sigma-Aldrich) |
| NVP | N-Vinyl pyrrolidone (Sigma-Aldrich) |
| NVC | N-Vinyl caprolactone (Sigma-Aldrich) |
| LA | Lauryl acrylate) (Sigma-Aldrich) |
| ODA | Octadecyl acrylate (Sigma-Aldrich) |
| SiMA | 3-(Trimethoxysilyl)propyl methacrylate |
| | (Sigma-Aldrich) |
| SiMac | Silicone macromer of MW approximately |
| | 10,000 (prepared as described for making |
| | “monomer C 3b” at column 16 of |
| | U.S. Pat. No. 4,693,935 (Mazurek)) |
| HPA-PA | Phosphorylated hydroxypropyl acrylate |
| | (Acryloyloxypropyl phosphate) |
| | CH₂═CHC(O)OCH₂CH₂CH₂OPO₃H |
| | (Prepared as described for SM-1) |
| TMAEMA-FP | Trimethylammoniumethyl methacrylate |
| | monosodium fluorophosphate |
| | CH₂═C(CH₃)C(O)OCH₂CH₂N(CH₃)₃^{⁺}OPFO₂Na⁻ |
| | (Prepared as described for SM-2) |
| TMAEMA-BF₄ | Trimethylammoniumethyl methacrylate |
| | tetrafluoroborate |
| | CH₂═C(CH₃)C(O)OCH₂CH₂N(CH₃)₃^{⁺}BF₄⁻ |
| | (Prepared as described for SM-3) |
| DMAEMA-C₁₆Br | Dimethylhexadecylammoniumethyl methacrylate |
| | bromide |
| | CH₂═C(CH₃)C(O)OCH₂CH₂N(CH₃)₂(C₁₆)^{⁺}Br⁻ |
| | (Prepared as described for SM-4) |
| TMAEMA-Cl | Trimethylammoniumethyl methacrylate Chloride |
| | CH₂═C(CH₃)C(O)OCH₂CH₂N(CH₃)₃^{⁺}Cl⁻ |
| | (CIBA Specialty Chemicals, Basel, Switzerland) |
| HPA | Hydroxypropyl acrylate (Sigma-Aldrich) |
| VAZO-67 | 2,2′-Azobis(2-methylbutanenitrile) (Dupont, |
| | Wilmington, DE) |
| UNILIN 425 | Long-chain alcohol surfactant |
| | (Baker Petrolite, Tulsa, OK) |
| UNITHOX 420 | Ethoxylated alcohol surfactant |
| | (Baker Petrolite, Tulsa, OK) |
| A46 | Aerosol grade blend of propane (19%) and |
| | isobutane (81%) Propellent (Technical |
| | Propellants, Morris, IL) |
| GML-12 | Glycerol monolaurate (Med-Chem Labs, Inc., |
| | Galena, IL) |
| CGP | Calcium glycerophosphate (Avocado |
| | Research Chemicals, Lancaster, England) |
| PHOSCAL | Caseinate material comprising a casein |
| | phosphoprotein-calcium phosphate complex. |
| | (NSI Dental, Australia) |
| NaF | Sodium fluoride (Sigma-Aldrich) |
| BHT | 2,6-Di-tert-butyl-4-methylphenol |
| | (Sigma-Aldrich) |
| THF | Tetrahydrofuran (Sigma-Aldrich) |
| IPA | Isopropyl alcohol (Sigma-Aldrich) |

### Preparation of Starting Materials

### Starting Material 1 (SM-1)

### Synthesis of Phosphorylated Hydroxypropyl Acrylate (HPA-PA)

A one liter flask fitted with mechanical stirrer, condenser, thermometer and a dropping funnel was charged with 120 parts THF, 0.01 parts BHT and 59 parts POCl₃. The flask was cooled with an ice/water/acetone bath. A premix of 50 parts HPA, 170 parts THF and 37 parts triethylamine were added from a dropping funnel at such a rate to maintain a temperature less than 5° C. and the mixture was stirred for 15 minutes. To the resulting mixture was added 170 parts THF and 0.01 parts BHT. A premix of 14 parts H₂O, 75 parts triethylamine and 170 parts THF was added very slowly so that the temperature remained less than 5° C. Then the reaction mixture was filtered to remove white solid salt. The filtrate was dried with anhydrous MgSO₄, filtered and the solvent removed by rotary evaporator under vacuum at 40° C. A pale yellow colored slightly viscous liquid was obtained. NMR analysis of this product revealed the structure of phosphorylated hydroxypropyl acrylate (HPA-PA).

### Starting Material 2 (SM-2)

### Trimethylammoniumethyl Methacrylate Monosodium Fluorophosphate (TMAEMA-FP)

A reaction flask fitted with a mechanical stirrer, thermometer and a dropping funnel was charged with 160 parts of an 80% aqueous solution of TMAEMA-Cl. A solution of 100 parts of disodium fluorophosphate (Alfa-Aesar, Ward Hill, Mass.) in 200 parts water was added dropwise to the reaction flask with stirring. The reaction solution was stirred for one hour at room temperature and the resulting reaction mixture transferred to a separatory funnel. Upon standing, two layers formed. The bottom layer was separated and discarded. The NMR spectrum of the top layer revealed the structure of trimethylammoniumethyl methacrylate monosodium fluorophosphates and solids analysis indicates 66 wt-% solids in water.

### Starting Material 3 (SM-3)

### Synthesis of Trimethylammoniumethyl Methacrylate Tetrafluoroborate (TMAEMA-BF₄)

A three-necked flask fitted with a mechanical stirrer, a dropping funnel and a condenser was charged with 80 parts of sodium tetrafluoroborate (Alfa Aesar Inorganics, Ward Hill, Mass.) and 130 parts of DI water. The mixture was stirred for 15 minutes and a clear solution was obtained. From the dropping funnel a solution of 202.4 parts of dimethylaminoethyl methacrylate-methyl chloride (trimethylammoniumethyl methacrylate chloride; CPS Company, Ciba, Crystal Lake, Ill.) and 80 parts of DI water was added slowly. A solid product immediately began to precipitate out. After the addition was complete, the mixture was stirred for 30 minutes and the solid isolated by filtration, washed with 30 parts of DI water, and dried under vacuum at 40° C. An NMR analysis of the solid product revealed the structure to be pure trimethylammoniumethyl methacrylate tetrafluoroborate.

### Starting Material 4 (SM-4)

### Synthesis of Dimethylhexadecylammoniumethyl Methacrylate Bromide (DMA-C₁₆Br)

A 500-ml round-bottom flask was charged with 42.2 parts of DMAEMA, 154.7 parts of acetone, 93.2 parts of 1-bromohexadecane (Sigma-Aldrich), and 0.34 parts of BHT. The mixture was stirred for 16 hours at 35° C. and then allowed to cool to room temperature. The resulting white solid precipitate was isolated by filtration, washed with cold ethyl acetate, and dried under vacuum at 40° C. An NMR analysis of the solid product revealed the structure to be pure dimethylhexadecylammoniumethyl methacrylate bromide.

### Dental Agents Blend A

Dental Agents Blend A was prepared by mixing NaF (49.75 parts), CGP (49.75 parts), and GML-12 (0.5 parts) for 24 hours to yield a homogeneous mixture.

### Dental Agents Blend B

Dental Agents Blend B was prepared by mixing NaF (49.75 parts), PHOSCAL (49.75 parts), and GML-12 (0.5 parts) for 24 hours to yield a homogeneous mixture.

### Foam Stabilizers Blend A

Foam Stabilizers Blend A was prepared by mixing UNILIN 425 (10 parts), UNITHOX 420 (10 parts), and ethanol (30 parts) in a glass jar with high sheer cowl mixing and heating to 150° C. with a heat gun. After 5 minutes of mixing the blend was isolated as a chalky, stable suspension.

### Examples 1-35

### Substantive Polymers

The substantive polymer p(NIPAAM/IBMA/AA/LA/TMAEMA-BF₄) that contained 20/45/20/5/10 parts by weight of the respective monomeric units, was prepared in an isopropyl alcohol solution according to the following procedure.

NIPAAM (20 parts), IBMA (45 parts), AA (20 parts), LA (5 parts), DMAEMA-BF₄ (10 parts), VAZO-67 (0.5 parts) and IPA (200 parts) were combined in a reaction vessel and the resulting mixture purged with nitrogen for 2 minutes. The vessel was sealed and maintained at 65° C. in a constant temperature-rotating device for 18 hours during which time a clear viscous polymer solution was formed. The reaction vessel was removed from the bath and cooled to room temperature. Percent solids analysis (33% solids in IPA) revealed a quantitative conversion to the polymer designated as Example 1.

Polymers designated as Examples 2-35 were prepared as generally described for Example 1 and are listed in Table 1 with monomeric units, weight ratios (of respective monomeric units), and form isolated (including alternate solvent and % solids, as appropriate) indicated. For some polymer preparations, other solvents, e.g. ethanol, ethanol/water and glycerol/ethanol were used at about 200 parts in place of IPA.

TABLE 1
Substantive Polymers

| | Monomeric Units | Weight % Ratio of | Form Polymer |
|---|---|---|---|
| Ex. | Of Substantive Polymer | Monomeric Units | Isolated |
| 1 | NIPAAM/IBMA/AA/LA/ | 20/45/20/5/10 | 33% in IPA |
| | TMAEMA-BF₄ | | |
| 2 | IBMA/NIPAAM/AA/ITA/ | 30/20/20/10/20 | 33% in IPA |
| | DMAEMA-C₁₆Br | | |
| 3A | IBMA/AA/DMAEMA-C₁₆Br | 60/20/20 | 36.8% in IPA |
| 3B | | | 25% in ethanol |
| 4 | IBMA/AA/TMAEMA-Cl | 60/20/20 | 33.8% in IPA |
| 5 | IBMA/SiMac/DMAEMA- | 60/20/20 | 32.0% in IPA |
| | C₁₆Br | | |
| 6 | HPA-PA/AA/ITA | 50/40/10 | 33% in EtOH/H₂O |
| | | | (3:1) |
| 7 | IBMA/AA/TMAEMA-FP/ | 40/20/20/20 | 32% in IPA |
| | DMAEMA-C₁₆Br | | |
| 8 | IBMA/AA/SiMac | 69/26/5 | 33% in IPA |
| 9 | IBMA/AA/ITA/LA | 65/20/10/5 | 33% in IPA |
| 10 | IOA/AA/ITA/LA | 65/20/10/5 | 33% in IPA |
| 11 | IOA/AA/SiMac | 69/26/5 | 33% in IPA |
| 12 | IBMA/AA/ITA/AA | 65/20/10/5 | 33% in IPA |
| 13 | IOA/NIPAAM/ISoBoA | 70/20/10 | 33% in IPA |
| 14 | IQA/NVC/ISoBoA | 70/20/10 | 33% in IPA |
| 15 | NIPAAM/IBMA/NVP | 50/20/30 | 33% in IPA |
| 16 | NVC/IBMA/AA/ITA | 45/22.5/25/7.5 | 33% in |
| | | | Glycerol/EtOH |
| | | | (1:1) |
| 17 | NVC/MEA/AA/ITA | 45/22.5/25/7.5 | 33% in EtOH/H₂O |
| | | | (1:1) |
| 18 | NIPAAM/MEA/AA/ITA/LA | 20/45/20/10/5 | 33% in EtOH/H₂O |
| | | | (1:1) |
| 19 | NIPAAM/IBMA/AA/ITA/LA | 20/45/20/5/10 | 33% in IPA |
| 20 | NIPAAM/IBMA/AA/ITA/LA | 20/45/20/10/5 | 33.5% in IPA |
| 21 | NIPAAM/IBMA/AA/LA | 20/55/20/5 | 34% in IPA |
| 22 | NIPAAM/IBMA/AA/ITA | 45/22.5/25/7.5 | 34% in IPA |
| 23 | IBMA/AA/ITA/TMAEMA- | 50/20/10/20 | 33% in IPA |
| | FP | | |
| 24 | IBMA/NIPAAM/AA/ITA/ | 30/20/20/10/20 | 33% in IPA |
| | DMAEMA-FP | | |
| 25 | IBMA/AA/DMAEMA-C₁₆Br | 69/26/5 | 25% in EtOH |
| 26 | IBMA/AA/DMAEMA-C₁₆Br/ | 64/26/5/5 | 26.2% in EtOH |
| | SiMac | | |
| 27 | IBMA/AA/DMAEMA- | 55/20/20/5 | 25% in EtOH |
| | C₁₆Br/SiMac | | |
| 28 | IBMA/AA/SiMac/SiMA | 64/26/5/5 | 25% in EtOH |
| 29 | IBMA/AA/DMAEMA- | 54/20/20/5/1 | 25% in IPA |
| | C₁₆Br/SiMac/SiMA | | |
| 30 | IBMA/AA/DMAEMA- | 53/20/20/5/2 | 24.7% in EtOH |
| | C₁₆Br/SiMac/SiMA | | |
| 31 | IBMA/AA/DMAEMA- | 63/26/5/5/1 | 26% in EtOH |
| | C₁₆Br/SiMac/SiMA | | |
| 32 | IBMA/AA/DMAEMA- | 46.2/23.1/7.7/23 | 31.2% in EtOH |
| | C₁₆Br/IOA | | |
| 33 | IBMA/IOA/AA/DMAEMA- | 30/30/30/10 | 25% in EtOH |
| | C₁₆Br | | |
| 34 | IBMA/AA/ODA/DMAEMA- | 40/30/20/10 | 25.2% in EtOH |
| | C₁₆Br | | |
| 35 | IBMA/AA/DMAEMA-C₁₆Br | 60/30/10 | 25.9% in EtOH |

### Examples 36-43

### Foamable Dental Compositions Containing Substantive Polymers

A solution of substantive polymer in ethanol (Example 3B) was formulated into foamable dental compositions using standard methodology and commercially available propellants according to the following general procedure.

The foamable dental compositions were formulated by combining a substantive polymer solution (Example 3B) (25% polymer in ethanol; 100 parts), the Foam Stabilizer Blend A (5 parts), and NaF (0, 5, 8, or 15 parts) in a glass jar with high sheer mixing for 5 minutes. The resulting mixtures were transferred to individual dispensing metal containers each equipped with an aerosol nozzle and sealed. An aerosol propellant (A-46) (16 parts) was added to the containers. The resulting foamable dental compositions were designated Examples 36, 37, 38, and 39 containing 0, 5, 8, and 15 parts of NaF, respectively.

Another foamable dental compositions (Example 40A) was prepared as described above for Examples 36-39, except that Dental Agents Blend A (5 parts) was substituted for the NaF.

Another foamable dental compositions (Example 40B) was prepared as described above for Examples 36-39, except that Dental Agents Blend B (5 parts) was substituted for the NaF.

Three other foamable dental compositions (Examples 41-43) were prepared as described above for Examples 36-39, except that NaF (2.5 parts or 5.0 parts) was combined with substantive polymer solution Example 2 (33% in IPA; 100 parts) or with Example 24 (33% in IPA; 100 parts). The resulting foamable dental compositions were designated as follows:

Example 41: Example 24 polymer solution (100 parts)+NaF (2.5 parts)

Example 42: Example 24 polymer solution (100 parts)+NaF (5.0 parts)

Example 43: Example 2 polymer solution (100 parts)+NaF (5.0 parts)

All foamable dental compositions (Examples 36-43) dispensed a foam composition that was satisfactory. The dispensed foams were stable and lasted for at least 3 minutes.

### Evaluations

Retention of Polymer Coatings on Teeth from Various Test Samples

Inventive test samples (Examples 8, 3A, and 27) were evaluated for length of retention on a bovine tooth surface according to the Colored Pigment Test Method 2 described herein and compared with the commercial material DURAPHAT Fluoride Varnish evaluated according to the Colored Pigment Test Method 3 described herein. The results for Examples 8, 3A, and 27 are provided in Table 2 and show that greater than 50% of the retentive coatings lasted for at least 3-4 “Test Days”, depending on the substantive polymer solution utilized. The coating formed from application of DURAPHAT Fluoride Varnish (DFV) was completely removed in less than 1 “Test Day.”

TABLE 2
Length of Retention of Test Sample Coatings
on Bovine Teeth after Toothbrushing

| | “Test Days” (1 Test Day = 26 Brushing Cycles) | | | | | | |
|---|---|---|---|---|---|---|---|
| Sample | 1 | 2 | 3 | 4 | 7 | 9 | 11 |
| Ex. 8 | 100 | 70 | 70 | 65 | 40 | 10 | 5 |
| Ex. 3 | 100 | 80 | 70 | 65 | 50 | 15 | 5 |
| Ex. 27 | 100 | 60 | 40 | 35 | 15 | 5 | 2 |
| DFV | 0 | | | | | | |

Retention of Polymer Coatings on Teeth from Various Test Samples

Inventive test sample (Example 37 foamable composition) was evaluated for length of retention on a bovine tooth surface according to the Colored Pigment Test Method 1 described herein and compared with the following commercial materials: ORAL B Foam, DURAPHAT Fluoride Varnish, COLGATE Toothpaste, and SCOPE Mouthwash. Observations of coating retention were made at time intervals from 1 minute to 5 days. Sample sources, compositions, and testing results are shown in Table 3. It is noted from the results in Table 3 that Example 37 provided a retentive coating that lasted for greater than 5 days. In contrast, the commercial Oral B Foam, COLGATE Toothpaste, and SCOPE Mouthwash products did not provide a retentive coating (less than 1, 2, and 3 minutes, respectively, on teeth). Both foam compositions were dispensed from similar types of aerosol foam containers. DURAPHAT Varnish also provided a retentive coating that lasted for greater than 5 days in this test.

TABLE 3
Length of Retention of Test Sample Coatings on Bovine Teeth

| | Composition or | Length of |
|---|---|---|
| Sample | Source of Sample | Retention |
| Example | Foamable Dental Composition | >5 Days |
| 37 | with Substantive Polymer | |
| Oral B | Sodium Fluoride-Containing Foaming Pro- | <1 Minute |
| Foam | duct (Oral-B Laboratories, Iowa City, IA) | |
| DURAPHAT | DURAPHAT Fluoride Varnish, (Colgate- | >5 Days |
| Varnish | Palmolive Company, Canton, MA) | |
| COLGATE | COLGATE “fluoride for cavity | <2 Minute |
| Toothpaste | protection; regular flavor” | |
| | toothpaste (Colgate-Palmolive Company) | |
| SCOPE | SCOPE “cool peppermint” | <3 Minute |
| Mouthwash | mouthwash, (Proctor & Gamble) | |

Fluoride Release from Surfaces Coated with Foamable Dental Compositions.

Inventive test samples (Examples 40A and 40B foamable compositions) were evaluated for fluoride release over time from a bovine tooth surface according to the Fluoride Release Test Method described herein and compared with the commercial DURAPHAT Fluoride Varnish product. Test results are provided in Table 4 and show similar fluoride release patterns over the course of the 4-hour study. However, it is noted that the ability of a foam formulation to be applied simultaneously to all teeth in the arch of a patient provides a significant time-saving advantage over what is generally possible with a varnish formulation.

TABLE 4
Fluoride Release over Time from Foamable Dental Compositions.

| | | Cumulative Fluoride Release (mg F/g Test | | |
|---|---|---|---|---|
| | | Sample) After Indicated Time | | |
| Example | Polymer | 0.5 hr | 1 hr | 4 hrs |
| 40A | Example 3A | 0.66 | 0.95 | 1.34 |
| 40B | Example 3A | 0.92 | 1.54 | 2.51 |

| | | | |
|---|---|---|---|
| DURAPHAT | 0.57 | 0.92 | 2.05 |
| Fluoride Varnish | | | |

Fluoride Release from Surfaces Coated with Foamable Dental Compositions.

Inventive test samples (Examples 41-43 foamable compositions) were evaluated for fluoride release over time according to the Fluoride Release Test Method described herein and compared with the commercial DURAPHAT Fluoride Varnish and Oral B Foam products. Test results are provided in Table 5 and show, for some test samples, dissimilar fluoride release patterns over the course of the 168-hour study.

TABLE 5
Fluoride Release over Time from Foamable Dental Compositions.

| | | Cumulative Fluoride Release | | | | | |
|---|---|---|---|---|---|---|---|
| | | (mg F/g Test Sample) After Indicated Time | | | | | |
| Example | Polymer | 0.5 hr | 1 hr | 2 hrs | 3 hrs | 24 hrs | 168 hrs |
| 41 | Ex. 24 | 1.58 | 1.96 | 2.00 | 2.04 | 2.20 | 2.27 |
| 42 | Ex. 24 | 1.76 | 2.28 | 2.34 | 2.36 | 3.03 | 3.14 |
| 43 | Ex. 2 | 1.95 | 3.98 | 4.44 | 4.49 | 7.69 | 18.77 |

| | | | | | | |
|---|---|---|---|---|---|---|
| DURAPHAT | 73.7 | 1.39 | 2.82 | 4.69 | 5.35 | 5.93 |
| Fluoride Varnish | | | | | | |

In the case of Oral B Foam, fluoride release was measured at 8.34 mg F/gram after 0.5 minutes, at 8.83 mg F/gram after 1 minute, and at 8.89 mg F/gram after 5 minutes. Therefore, about 94% of the fluoride released over 5 minutes was released at 0.5 minutes and 99% released at 1 minute. It is concluded that Oral B Foam did not form a retentive coating on a dental restorative surface.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A foamable dental composition comprising a film-forming component, wherein the film-forming component forms a retentive polymeric coating on a dental surface, wherein the retentive polymeric coating remains on the dental surface for at least 15 minutes under normal intraoral conditions.

2. The foamable dental composition of claim 1 wherein the retentive polymeric coating remains on a bovine tooth enamel surface for at least 12 hours after 2 tooth brushings according to the Colored Pigment Test Method 2.

3. The foamable dental composition of claim 1 further comprising a carrier.

4. The foamable dental composition of claim 3 wherein the carrier comprises water, alcohol, glycerol, ethyl acetate, methyl acetate, butyl acetate, pinene, and combinations thereof.

5. The foamable dental composition of claim 1 further comprising a dental agent.

6. The foamable dental composition of claim 5 wherein the dental agent is selected from the group consisting of a fluoride source, a whitening agent, an anticaries agent, a remineralizing agent, an enzyme, a breath freshener, an anesthetic, a clotting agent, an acid neutralizer, a chemotherapeutic agent, an immune response modifier, a medicament, an indicator, an antimicrobial agent, an antifungal agent, an agent for treating xerostomia, a desensitizer, and combinations thereof.

7. The foamable dental composition of claim 6 wherein the dental agent is capable of remineralizing enamel.

8. The foamable dental composition of claim 7 wherein the dental agent is selected from the group consisting of a phosphate compound, a calcium compound, a calcium phosphate compound, hydroxyapatite, a caseinate, a filler having a surface-treatment of a phosphorus compound, a phosphorous releasing glass, a calcium releasing glass, and combinations thereof.

9. The method of claim 8 wherein the dental agent is a phosphate compound.

10. The method of claim 9 wherein the phosphate compound is selected from the group consisting of a monobasic phosphate compound, a dibasic phosphate compound, a tribasic phosphate compound, calcium glycerophosphate, and combinations thereof.

11. The method of claim 8 wherein the dental agent is a caseinate.

12. The foamable dental composition of claim 1 wherein the film-forming component comprises a substantive polymer.

13. The foamable dental composition of claim 12 wherein the substantive polymer is water-dispersible.

14. The foamable dental composition of claim 12 wherein the substantive polymer comprises:
a repeating unit comprising a polar or polarizable group;
a repeating unit comprising a group selected from the group consisting of a hydrophobic hydrocarbon group, a graft polysiloxane chain, a hydrophobic fluorine-containing group, and combinations thereof; and
a repeating unit comprising a modulating group.

15. The foamable dental composition of claim 14 wherein at least one of the groups comprises a reactive group.

16. The foamable dental composition of claim 1 wherein the film-forming component comprises a substantive polymer comprising a hydrophobic segment, a hydrophilic segment, and a silicon-containing macromer segment.

17. The foamable dental composition of claim 16 wherein the substantive polymer further comprises a quaternary amine segment.

18. The foamable dental composition of claim 17 wherein the substantive polymer further comprises and an alkoxy silane crosslinkable segment.

19. The foamable dental composition of claim 1 wherein the film-forming component comprises a substantive polymer comprising a hydrophobic segment, a hydrophilic segment, and a quaternary amine segment.

20. The foamable dental composition of claim 19 wherein the substantive polymer further comprises an alkoxy silane crosslinkable segment.

21. The foamable dental composition of claim 1 wherein the film-forming component comprises a substantive polymer comprising a hydrophobic segment, a hydrophilic segment, a silicon-containing macromer segment, and an alkoxy silane crosslinkable segment.

22. The foamable dental composition of claim 1 further comprising a propellant.

23. The foamable dental composition of claim 22 wherein the propellant comprises a gas selected from the group consisting of air, nitrogen, oxygen, carbon dioxide, helium, argon, nitrous oxide, hydrocarbons, and mixtures thereof.

24. The foamable dental composition of claim 1 further comprising a foaming agent.

25. The foamable dental composition of claim 24 wherein the foaming agent is selected from the group consisting of a surfactant, surface-modified nanoparticles, a foam stabilizer, a foam-wall thickener, and combinations thereof.

26. The foamable dental composition of claim 25 wherein the foaming agent is a surfactant.

27. The foamable dental composition of claim 26 wherein the surfactant comprises a polymerizable surfactant.

28. The foamable dental composition of claim 25 wherein the foaming agent comprises surface-modified nanoparticles.

29. The foamable dental composition of claim 1 further comprising a polymerizable component.

30. The foamable dental composition of claim 1 further comprising an additive selected from the group consisting of a buffering agent, an acidifying agent, hydrofluoric acid, an emulsifier, an emulsion oil, an emulsion stabilizer, a remineralizing promoting agent, a viscosity modifier, a thixotrope, a filler, a polyol, a flavoring agent, and combinations thereof.

31. A foamable dental composition comprising a film-forming component and a carrier, wherein the film-forming component forms a retentive polymeric coating on a dental surface, wherein the retentive polymeric coating remains on a bovine tooth enamel surface for at least 12 hours after 2 tooth brushings according to the Colored Pigment Test Method 2.

32. A method of forming a retentive polymeric coating on a dental surface, the method comprising:
providing a foamable dental composition comprising a film-forming component;
foaming the composition to produce a dental foam; and
applying the dental foam to a dental surface;
wherein the film-forming component forms a retentive polymeric coating on the dental surface, wherein the retentive polymeric coating remains on the dental surface for at least 15 minutes under normal intraoral conditions.

33. The method of claim 32 wherein applying the dental foam to a dental surface comprises painting the foam, brushing the foam, syringing the foam, wiping the foam, applying the foam from a substrate, dip coating the foam, or combinations thereof.

34. The method of claim 33 wherein the substrate is a dental tray.

35. The method of claim 32 wherein applying the dental foam to a dental surface comprises dip coating the dental surface in the dental foam for less than five minutes.

36. The method of claim 35 wherein applying the dental foam to a dental surface comprises dip coating the dental surface in the dental foam for at least one second.

37. The method of claim 32 further comprising rinsing the dental surface immediately after applying the dental foam.

38. The method of claim 32 wherein the dental surface comprises gums or a tooth surface.

39. The method of claim 32 wherein the dental surface comprises a cured dental restorative material.

40. The method of claim 32 wherein the dental surface comprises a ceramic tooth.
